(19) United States
(12) Patent Application Publication
(10) Pub. No.: US 2014/0320279 A1
(43) Pub. Date: Oct. 30, 2014

(54) Signaling Systmem

(71) Applicant: Roy V. Stuart, Las Vegas, NV (US)

(72) Inventor: Roy V. Stuart, Las Vegas, NV (US)

(21) Appl. No.: 13/869,491

(22) Filed: Apr. 24, 2013

(51) Int. Cl. B60Q 1/44

(52) U.S. Cl. CPC B60Q 1/44
USPC 340/479

(57) ABSTRACT

A signaling system allows a front vehicle to give advance notifications of signaling intentions to a rear vehicle by activating an intent signal on a vehicle when an object, such as a foot, is in proximity to, and/or moving towards, a signal actuator. A detector portion emits a motion signal, such as a plurality of optical beams that form a grid on a planar surface of the brake pedal. An interruption in the grid actuates a radio frequency signal from the detector positioned in proximity to the brake pedal, to an indicator portion, positioned in a rear visible area of the vehicle. The indicator includes a light emitting diode strip that is visible from the car and may tilt and orient for variable viewing angles. The illumination from the indicator differs from the brake illumination to differentiate between intent to brake and actual braking.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to signaling systems. More particularly, the invention relates to vehicle signaling systems that give advance notifications of signaling intentions from a vehicle.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a brake is a mechanical device which inhibits motion. Most commonly, brakes use friction to convert kinetic energy into heat, though other methods of energy conversion may be employed.

Typically, the lighting system of a motor vehicle consists of lighting and signaling devices mounted or integrated to the front, sides, rear, and in some cases the top of the motor vehicle. The purpose of this system is to provide illumination for the driver to operate the vehicle safely after dark, to increase the conspicuity of the vehicle, and to display information about the vehicle's presence, position, size, direction of travel, and driver's intentions regarding direction and speed of travel.

Often, a motion detector is a device that detects moving objects, particularly people. A motion detector is often integrated as a component of a system that automatically performs a task or alerts a user of motion in an area. Motion detectors form a vital component of security, automated lighting control, home control, energy efficiency, and other useful systems.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective view of an exemplary signaling system, in accordance with an embodiment of the present invention;

FIG. 2 illustrates a detailed perspective view of an exemplary front vehicle signaling an intent to brake to an exemplary rear vehicle, in accordance with an embodiment of the present invention;

FIG. 3 illustrates a detailed perspective view of an exemplary detector portion, in accordance with an embodiment of the present invention,

FIGS. 4A, 4B, and 4C illustrate detailed perspective views of exemplary detector portions in various orientations, in accordance with an embodiment of the present invention;

FIGS. 5A and 5B illustrate detailed perspective views of exemplary detector portion mounts joined with exemplary detector portions in various orientations, in accordance with an embodiment of the present invention;

FIGS. 6A, 6B, and 6C illustrate detailed perspective views of exemplary detector portions emitting various motion signals after adjustment of an exemplary lens portion, in accordance with an embodiment of the present invention;

FIGS. 7A and 7B illustrate detailed perspective views of exemplary detector portion emitting exemplary motion signals from various positions around an exemplary signal actuator, in accordance with an embodiment of the present invention; and

FIGS. 8A, 8B, 8C, 8D, and 8E illustrate detailed perspective views of exemplary indicator portions in various orientations, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of signaling systems that may be provided by preferred embodiments of the present invention. In one embodiment of the present invention, the signaling system may give advance notifications of signaling intentions. The signaling system may automatically activate an intent signal on a vehicle when an object is in proximity to, and/or moving towards, a signal actuator. A detector portion emits a motion signal that may be interrupted by the object. In this manner, intent to apply brakes in a vehicle may be signaled prior to the brakes actually being applied, as the detector portion detects movement of a foot moving towards a brake pedal. In some other embodiments, the signaling system may be configured to also signal parameters such as presence, position, size, direction of travel. In yet other embodiments, the signaling system may be configured to indicate direction of travel.

In one embodiment of the present invention, a detector portion positions near a signal actuator, so as to detect motion of an object moving towards, and in proximity to the motion actuator. The detector portion may include an optic beam transmitter that transmits a motion signal, such as optic light beams, in grid formation over and around the signal actuator. Disturbance of the grid formation by an object may actuate the detector portion to perform the task of alerting to the disturbance. However, in other embodiments, the detector portion may include, without limitation, an ultrasonic detector that transmits pulses of ultrasonic waves and measures the reflection off a moving object, a microwave detector that transmits microwave pulses and measures the reflection off a moving object, and a tomographic detector that senses disturbances to radio waves as they travel through an area surrounded by mesh network nodes. In some embodiments, the signal actuator may include, without limitation, a brake pedal of a vehicle, a turn signal, a gas pedal, and a clutch.

In one embodiment of the present invention, the detector portion may include a lens portion, such as optic eyes, that are contained within housing. The lens portion may help transmit and refract light, converging or diverging the optical beam to form an effective grid formation. The grid formation may be configured so as to cover the appropriate signal actuator, while also not interfering with the space of other signal actuators. In this manner, pressing on the clutch will not accidently trigger the detector portion on the brake pedal. The housing may further include a power source, a radio frequency transmitter, wiring, and circuitry. In some embodiments, the detector portion may include a signaling portion to transmit the detected motion through a signal, such as a radio frequency. Those skilled in the art, in light of the present teachings, will recognize that a radio frequency is a rate of oscillation in the range of about 3 kHz to 300 GHz, which is reliable and not easily disturbed.

In one embodiment of the present invention, the signal may transmit in response to disturbance to the formation grid. The signal may transmit from the signaling portion of the detector portion to a receiver portion in the indicator portion. The indicator portion may include an illumination device that positions on a rear portion of a vehicle. The indicator portion may illuminate whenever the signal is received from the detector portion. In this manner, a motorist driving behind a vehicle with the indicator portion installed may be notified of intent to brake. The indicator portion may further include a receiver portion for receiving the radio frequency. In some embodiments, the indicator portion may integrate with a brake light, whereby a plurality of different illuminations may delineate between intent to brake, and an actual brake. A mount may join the signaling portion with an area of the vehicle, including, without limitation, a rear window, a brake light, and a bumper of a vehicle. The mount may allow the indicator portion to adjustable tilt and pivot for enhanced viewing by other motorists.

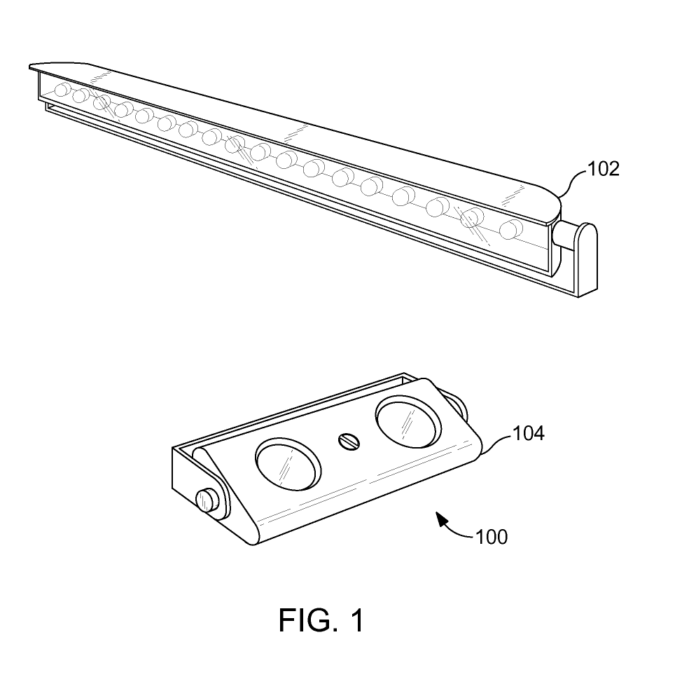

FIG. 1 illustrates a detailed perspective view of an exemplary signaling system, in accordance with an embodiment of the present invention. In the present invention, a signaling system 100 may give advance notifications of signaling intentions of a vehicle. The signaling intention may include, without limitation, intent to brake, an intent to turn, and an intent to accelerate. The signaling system may automatically activate an intent signal on a vehicle when an object is in proximity to, and/or moving towards, a signal actuator. A detector portion emits a motion signal that may be interrupted by the object. In one embodiment, the signaling system may be adjustable to dictate a predetermined speed, distance, and trajectory the object may follow to activate the intent signal. In this manner, intent to apply brakes in a vehicle may be signaled prior to the brakes actually being applied, as a detector portion 102 detects movement of a foot moving towards a brake pedal, and signals to an indicator portion 104. The detector portion and the indicator portion may be operatively joined to communicate the intent to signal through various signals.

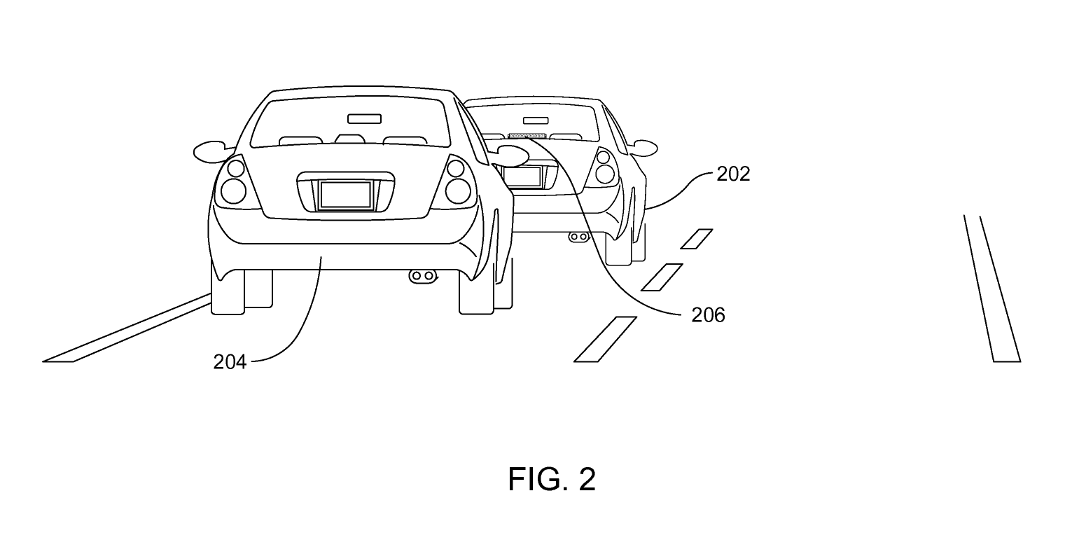

FIG. 2 illustrates a detailed perspective view of an exemplary front vehicle signaling intent to brake to an exemplary rear vehicle, in accordance with an embodiment of the present invention. In the present invention, a front vehicle 202 may signal intent to brake to a rear vehicle 204. A braking intent signal 206 from the front vehicle may provide a safety feature that helps prevent accidents and sudden breaks by the rear vehicle. Those skilled in the art, in light of the present teachings, will recognize that rear end collisions often occur because a rear vehicle only realizes that the front vehicle is breaking at the last moment. An intent signal that illuminates, even a second or two prior to the front vehicle breaking, may provide the rear vehicle sufficient time to react to the breaking.

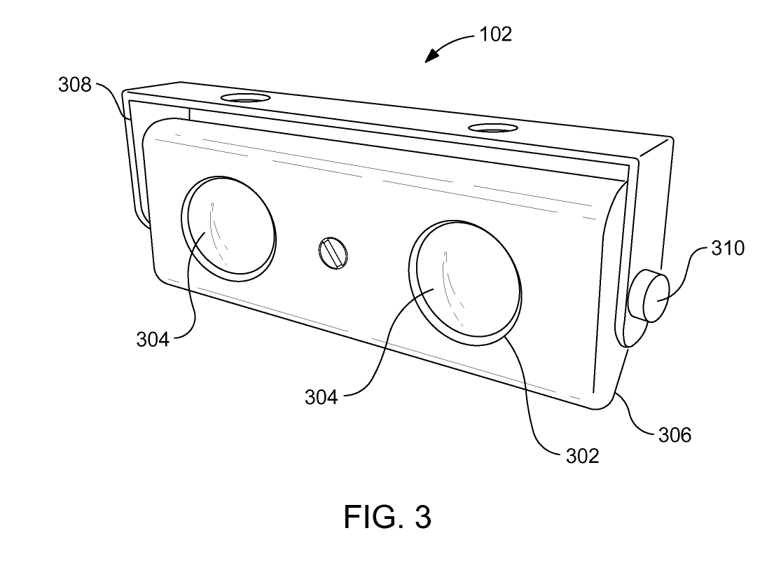

FIG. 3 illustrates a detailed perspective view of an exemplary detector portion, in accordance with an embodiment of the present invention. In the present invention, a detector portion positions near a signal actuator, so as to detect motion of an object moving towards, and in proximity to the signal actuator. The detector portion may include a signaling portion 302 for transmitting a motion signal. The lens portion may include, without limitation, an optic beam transmitter that transmits a motion signal, such as optic light beams, in grid formation over and around the signal actuator. In some embodiments, interruption of the grid formation by an object may actuate the detector portion to perform the task of alerting to the disturbance. For example, without limitation, a foot moving towards a brake pedal at a predetermined speed from a predetermined distance. However, in other embodiments, the detector portion may include, without limitation, an ultrasonic detector that transmits pulses of ultrasonic waves and measures the reflection off a moving object, a microwave detector that transmits microwave pulses and measures the reflection off a moving object, and a tomographic detector that senses disturbances to radio waves as they travel through an area surrounded by mesh network nodes. In some embodiments, the signal actuator may include, without limitation, a brake pedal of a vehicle, a turn signal, a gas pedal, and a clutch.

In one embodiment of the present invention, the detector portion may include a lens portion 304, such as optic eyes, that are contained within housing. The lens portion may help transmit and refract light, converging or diverging the optical beam to form an effective grid formation. The grid formation may be configured so as to cover the appropriate signal actuator, while also not interfering with the space of other signal actuators. In this manner, pressing on the clutch will not accidently trigger the detector portion on the brake pedal. The housing may further include a power source, a radio frequency transmitter, wiring, and circuitry. In some embodiments, the detector portion may include a signaling portion to transmit the detected motion through a signal, such as a radio frequency. Those skilled in the art, in light of the present teachings, will recognize that a radio frequency is a rate of oscillation in the range of about 3 kHz to 300 GHz, which is reliable and not easily disturbed. The detector portion may include a housing 306 for at least partially encasing the lens portion and the signaling portion. A mount 308 may join with the housing to allow for directional movement of the lenses towards a desired area of the signal actuator. The mount may include, without limitation, a semi-cylindrical column adjustable to ensure broadcast directly over the plane of the signal actuator. A detector adjustment portion 310 may alter the ability of the housing to move inside the mount.

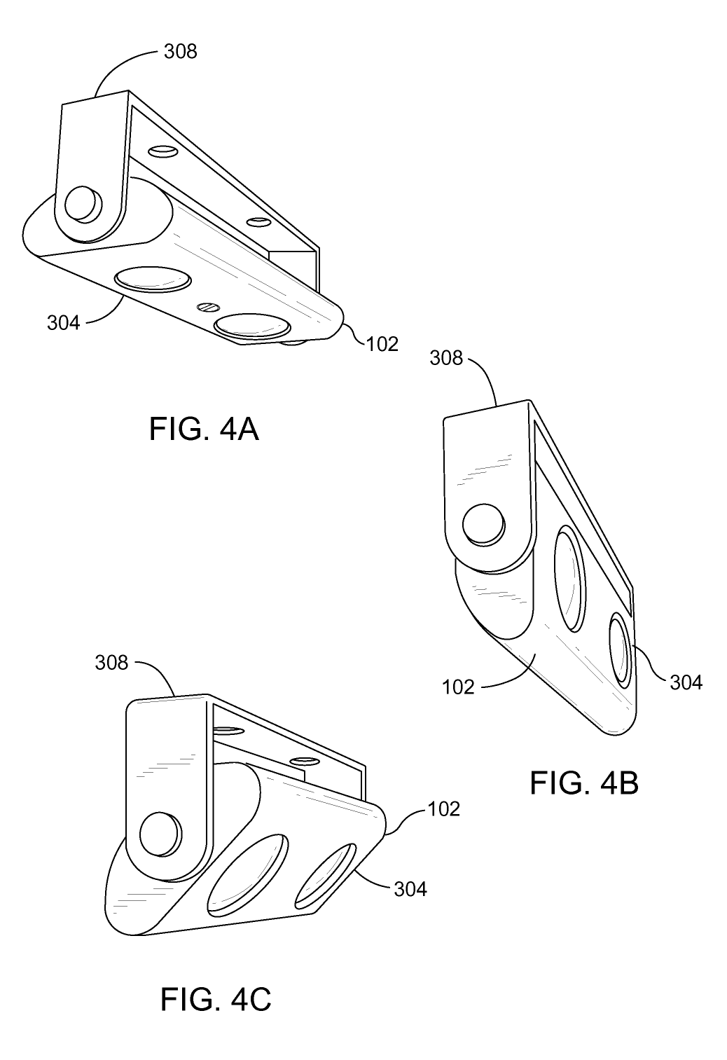

FIGS. 4A, 4B, and 4C illustrate detailed perspective views of exemplary detector portions in various orientations, in accordance with an embodiment of the present invention. In the present invention, the detector portion may include a housing for carrying the detector portion. The housing may be configured to join with a vehicle in proximity to a signal actuator. In some embodiments, the detector portion may be oriented so as to provide a grid formation on the signal actuator. The detector portion may swivel up to 360 degrees for better positioning in the vehicle and directed transmission of the motion signal.

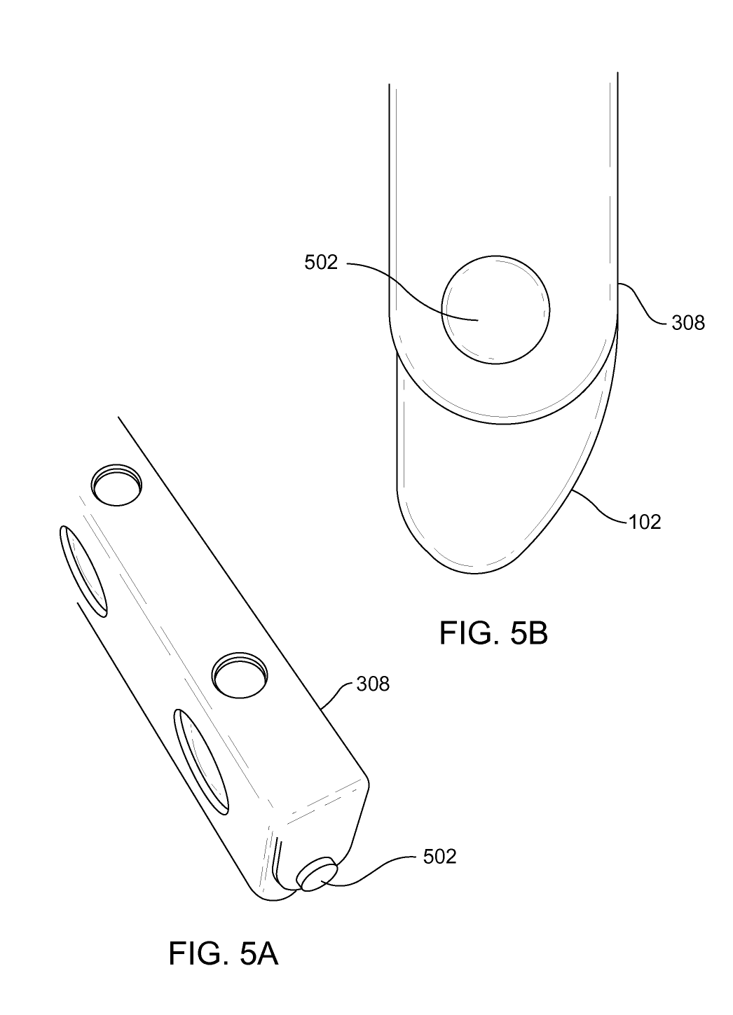

FIGS. 5A and 5B illustrate detailed perspective views of exemplary detector portion mounts joined with exemplary detector portions in various orientations, in accordance with an embodiment of the present invention. In the present invention, a release portion 502 may separate the detector portion from the housing. The release portion may include, without limitation, spring loaded tabs. Depressing the release portion may at least partially allow the detector portion to slide out for maintenance or cleaning.

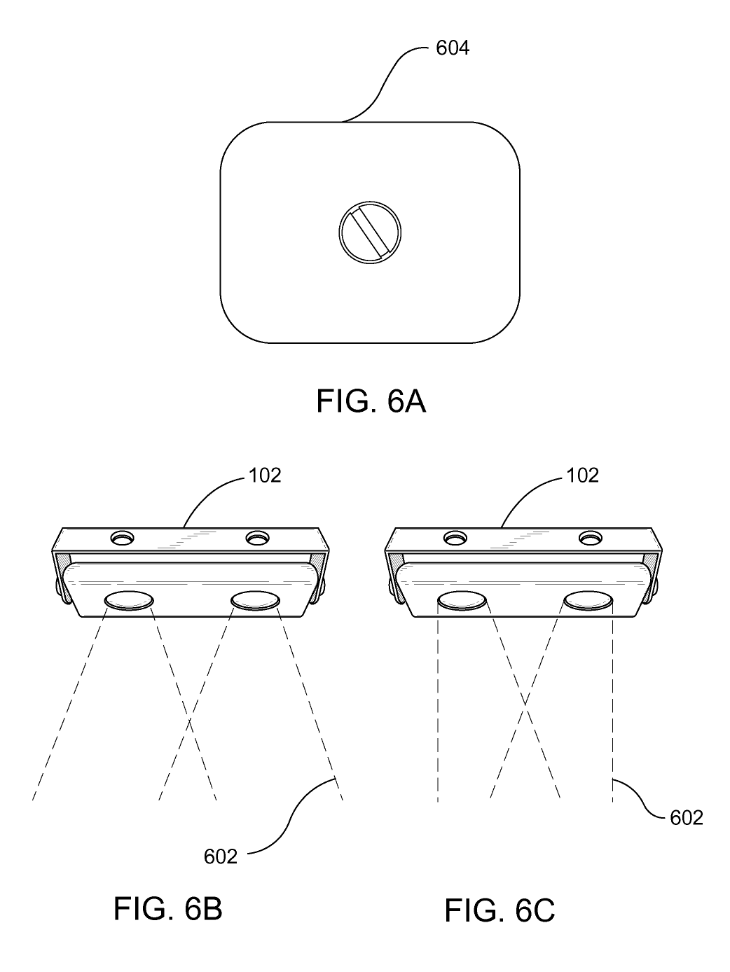

FIGS. 6A, 6B, and 6C illustrate detailed perspective views of exemplary detector portions emitting various motion signals after adjustment of an exemplary lens portion, in accordance with an embodiment of the present invention. In the present invention, a motion signal 602 may emit from the detector portion. The motion signal may include, without limitation, a plurality of optical beams, microwaves, infra-red radiation, and thermal energy. A lens adjustment portion 604 may serve to control the width of the grid formation, including, without limitation, an optic beam grid. In this manner, the motion signal does not overlap an adjacent signal actuator.

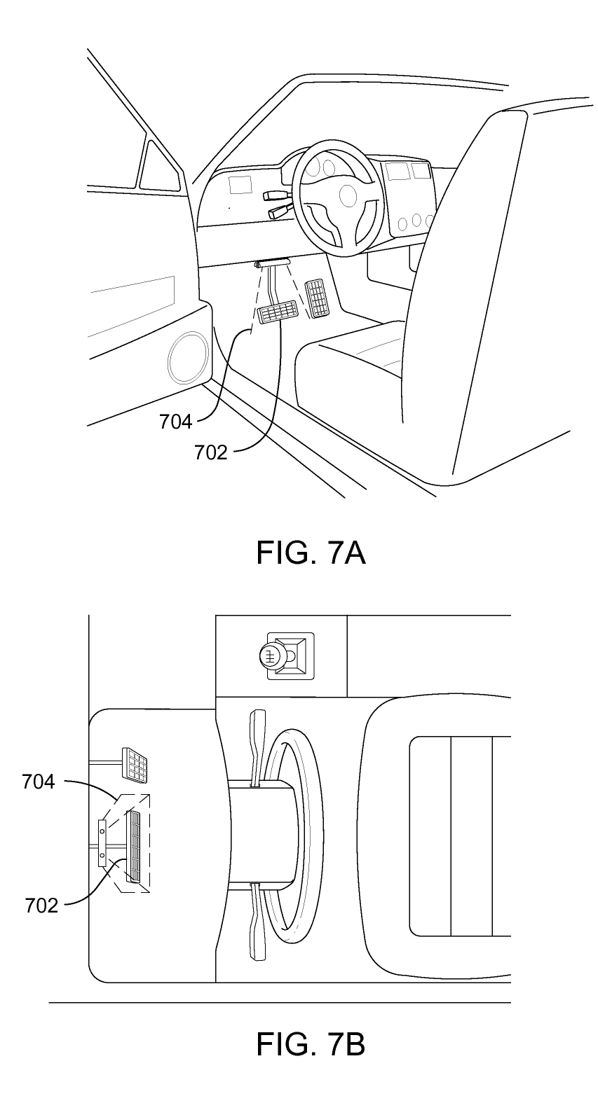

FIGS. 7A and 7B illustrate detailed perspective views of exemplary detector portion emitting exemplary motion signals from various positions around an exemplary signal actuator, in accordance with an embodiment of the present invention. In the present invention, a signal actuator 702 may include a brake pedal for braking of a vehicle. The signal actuator may position in proximity to the motion detector, whereby the grid formation may at least partially cover. In some embodiments, the motion detector may position above the signal actuator, and emit a motion signal onto the signal actuator. In another embodiment, the signal actuator may position adjacent to the motion detector. The motion signal may be adjusted to achieve an appropriate grid formation 704 that covers a substantial portion of the signal actuator, but does not cover an adjacent signal actuator. In this manner, the intent signal may be segregated to function only for designated signals, such as brakes. Whereby pressing the gas pedal and the clutch may not actuate the signaling system.

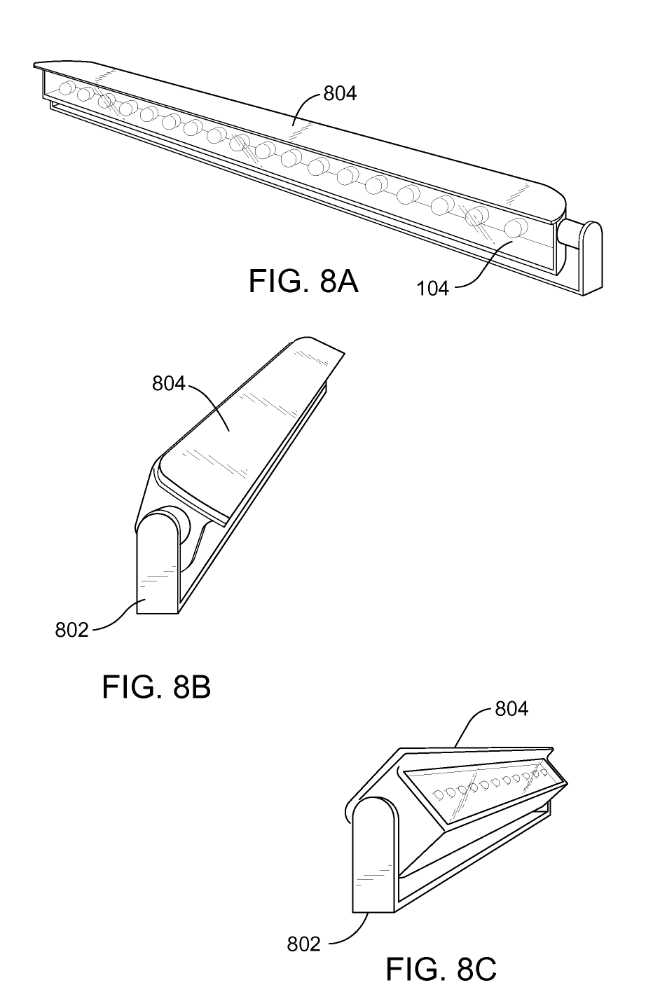

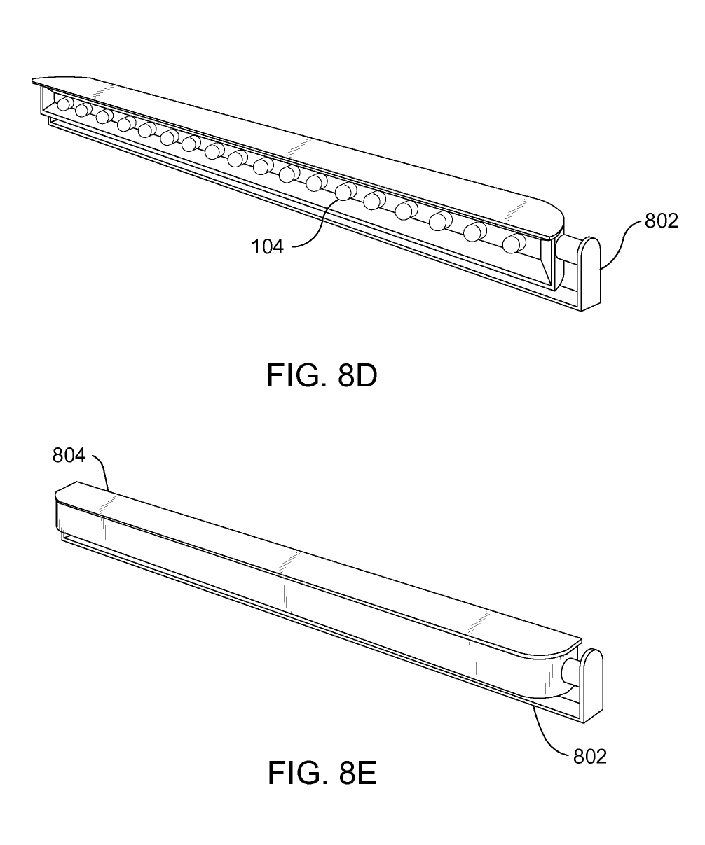

FIGS. 8A, 8B, 8C, 8D, and 8E illustrate detailed perspective views of exemplary indicator portions in various orientations, in accordance with an embodiment of the present invention. In the present invention, an indicator portion may receive the signal, and consequently actuate an illumination. The signal may transmit in response to an interruption to the formation grid. The signal may transmit from the signaling portion of the detector portion to a receiver portion in the indicator portion. Those skilled in the art, in light of the present teachings, will recognize that the indicator portion may include an illumination device that positions on a rear portion of a vehicle. The illumination from the indicator portion may include a bright light contained within a plastic housing with a transparent amber lens. The amber lens may look similar to an orange face lens over existing blinker lights. The indicator portion may illuminate whenever the signal is received from the detector portion. In this manner, a motorist driving behind a vehicle with the indicator portion installed may be notified of intent to brake. The indicator portion may further include a receiver portion for receiving the radio frequency. In some embodiments, the indicator portion may integrate with a brake light, whereby a plurality of different illuminations may delineate between intent to brake, and an actual brake. An indicator mount 802 may join the signaling portion with an area of the vehicle, including, without limitation, a rear window, a brake light, and a bumper of a vehicle. The indicator mount may allow the indicator portion to adjustable tilt and pivot for enhanced viewing by other motorists. For example, without limitation, the indicator portion may be mounted to the interior roof or rear dash of a vehicle, thereby being easily visible from the back window of the vehicle. In other embodiments, the indicator mount may join with the vehicle through various fasteners, including, without limitation, hook and loop fasteners, magnets, welding, and adhesives. The ability to adjust angle ensures that the notification light is easily visible by the rear vehicle. An indicator housing 804 may at least partially enclose the components of the indicator portion, also joining with the indicator mount.

In one alternative embodiment, the indicator portion may utilize audio signals in conjunction with illumination to indicate intent of braking. In yet another alternative embodiment, the position of the detector portion may adjust relative to the position of the vehicle seat, whereby adjustments in seat positioning do not affect sensitivity of the optical beams on the brake pedal. In yet another alternative embodiment, the detector portion detects thermal energy from the foot, including, without limitation, a passive infra-red radiation.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing a signaling system that signals intent to brake from a vehicle according to the present invention will be apparent to those skilled in the art. Various aspects of the invention have been described above by way of illustration, and the specific embodiments disclosed are not intended to limit the invention to the particular forms disclosed. The particular implementation of the signaling system that signals intent to brake from a vehicle may vary depending upon the particular context or application. By way of example, and not limitation, the signaling system that signals intent to brake from a vehicle described in the foregoing were principally directed to a motion detector that emits a signal that when disturbed by a foot coming in proximity to the pedal, signals to a distal illumination to illuminate implementations; however, similar techniques may instead be applied to race car driving, where spilt second decisions, such as braking, getting gas, and accelerating are vital, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a detector portion, said detector portion being disposed to position on a signal actuator, said detector portion being operable to emit a motion signal, said motion signal being configured to at least partially form a grid formation in proximity to said signal actuator, said detector portion being configured to transmit a signal when said grid formation is interrupted; and
an indicator portion, said indicator portion being configured to receive said signal, said indicator portion being operable to indicate when said grid formation is interrupted.

2. The system of claim 1, in which said detector portion comprises an optical beam transmitter.

3. The system of claim 1, in which said detector portion comprises a lens portion, said lens portion comprising two convex lenses.

4. The system of claim 1, in which said signal actuator comprises a brake pedal.

5. The system of claim 1, in which said motion signal comprises a plurality of optic beams.

6. The system of claim 5, wherein said plurality of optic beams at least partially covers said signal actuator to form said grid formation.

7. The system of claim 1, wherein interruption of said grid formation comprises a foot moving towards, and/or positioning in proximity to said signal actuator.

8. The system of claim 1, in which said detector portion comprises a signaling portion.

9. The system of claim 1, in which said signal comprises a radio frequency.

10. The system of claim 1, in which said indicator portion comprises a light emitting diode device.

11. The system of claim 10, wherein said light emitting diode device emits an indication illumination.

12. The system of claim 11, wherein said indication illumination illuminates differently from a brake illumination.

13. The system of claim 1, in which indicator portion comprises an indicator housing.

14. The system of claim 1, in which indicator portion comprises a receiver portion.

15. The system of claim 1, in which said indicator portion comprises an indicator mount.

16. The system of claim 15, wherein said indicator mount is configured to join said indicator portion at a rear portion of a vehicle.

17. The system of claim 16, wherein said indicator mount comprises a bracket, said indicator portion being disposed to fit inside said bracket.

18. The system of claim 17, wherein said bracket at least partially tilts to adjust an orientation of said indicator portion.

19. A system comprising:
means for positioning a detector portion on a signal actuator;
means for emitting a motion signal;
means for adjusting said motion signal to form a grid formation in proximity to said signal actuator;
means for interrupting said grid formation;
means for signaling to an indicator portion; and
means for indicating said interruption of said grid formation.

20. A system consisting of:
a detector portion, said detector portion comprising an optical beam, said detector portion comprising a lens portion, said lens portion comprising a plurality of convex lenses, said detector portion being disposed to position on a signal actuator, said signal actuator comprising a brake pedal, said detector portion being operable to emit a motion signal, said motion signal comprising a plurality of optical beams, said motion signal being configured to at least partially form a grid formation in proximity to said signal actuator, said detector portion being configured to transmit a signal when said grid formation is interrupted, said signal comprising a radio frequency; and
an indicator portion, said indicator portion comprising a light emitting diode device, said indicator portion further comprising an indicator mount, said indicator portion further comprising an indicator housing, said indicator portion further comprising a receiver portion, said indicator portion being configured to receive said signal, said indicator portion being operable to indicate when said grid formation is interrupted, said indicator portion being operable to emit a different illumination than a brake illumination.
